(19) United States
(12) Patent Application Publication
(10) Pub. No.: US 2021/0312814 A1
(43) Pub. Date: Oct. 7, 2021

(54) VEHICLE, DEVICE, AND METHOD

(71) Applicant: HONDA MOTOR CO., LTD., Tokyo (JP)

(72) Inventor: Kaname Tokita, Wako-shi (JP)

(21) Appl. No.: 17/352,997

(22) Filed: Jun. 21, 2021

Related U.S. Application Data
(63) Continuation of application No. PCT/JP2018/048565, filed on Dec. 28, 2018.

(51) Int. Cl. G08G 1/00; B60W 60/00; H04W 4/46

(52) U.S. Cl. CPC G08G 1/22; B60W 60/00; B60W 2554/4041; B60W 2556/65; H04W 4/46

(57) ABSTRACT

A vehicle includes a communication unit configured to communicate with a target, a detection unit configured to detect a target outside the vehicle, a specification unit configured to specify, from targets detected by the detection unit, a target to be a communication target, and a determination unit configured to determine consistency between a communication party target of the communication unit and the target specified by the specification unit. The determination unit determines whether the number of communication party targets of the communication unit and the number of targets specified by the specification unit match.

### CROSS-REFERENCE TO RELATED APPLICATION(S)

This application is a Continuation of International Patent Application No. PCT/JP2018/048565, filed Dec. 28, 2018, the entire disclosures of which is incorporated herein by reference.

### BACKGROUND OF THE INVENTION

### Field of the Invention

The present invention relates to a vehicle, a device, and a method.

### Description of the Related Art

Techniques for providing information to a vehicle by using vehicle-to-vehicle communication and road-to-vehicle communication have been proposed (Japanese Patent Laid-Open No. 2005-286557, Japanese Patent Laid-Open No. 2008-46820 and Japanese Patent Laid-Open No. 2011-191814).

Using such techniques will allow a plurality of vehicles to perform a uniform operation or a cooperative operation. In addition, a vehicle and a pedestrian who is holding a communication terminal or fixed equipment, such as a traffic light including a communication device, and a vehicle or a pedestrian will be able to perform a uniform operation or a cooperative operation in a similar manner. These operations can contribute to improving the safety and the flow of traffic. However, for example, there may be a case in which a vehicle that is not participating in the communication is present among a group of vehicles traveling near each other. This non-participating vehicle will not be a target of the uniform operation or the cooperative operation. Also, it will be difficult to confirm the presence of a non-participating vehicle by using only vehicle-to-vehicle communication and road-to-vehicle communication.

### SUMMARY OF THE INVENTION

An object of the present invention is to provide a technique that allows the presence of a communication party to be confirmed can be provided.

According to an aspect of the present invention, there is provided a vehicle comprising: a communication unit configured to communicate with a target that has a communication function; a detection unit configured to detect a target outside the vehicle; a specification unit configured to specify, from targets detected by the detection unit, a target to be a communication target; and a determination unit configured to determine consistency between a communication party target of the communication unit and the target specified by the specification unit, wherein the determination unit determines whether the number of communication party targets of the communication unit and the number of targets specified by the specification unit match.

Further features of the present invention will become apparent from the following description of exemplary embodiments (with reference to the attached drawings).

### BRIEF DESCRIPTION OF THE DRAWINGS

FIG. 1 is a block diagram of a vehicle and a control apparatus according to an embodiment;

FIG. 2 is a flowchart showing an example of processing to be executed by a vehicle control apparatus of FIG. 1;

FIG. 3 is a flowchart showing an example of the processing to be executed by the vehicle control apparatus of FIG. 1;

FIG. 4 is a view showing an example of cooperative operation by a plurality of vehicles;

FIG. 5 is a flowchart showing an example of the processing to be executed by the vehicle control apparatus of FIG. 1;

FIG. 6 is a flowchart showing an example of the processing to be executed by the vehicle control apparatus of FIG. 1;

FIG. 7 is a flowchart showing an example of the processing to be executed by the vehicle control apparatus of FIG. 1;

FIG. 8 is a view showing an example of consistency between communication-party vehicles and vehicles detected by sensors;

FIG. 9 is a view showing an example of inconsistency between the communication-party vehicles and the vehicles detected by the sensors;

FIG. 10 is a view showing an example of inconsistency between communication-party vehicles and vehicles detected by sensors;

FIG. 11 is a view showing an example of obtaining a target detected by sensors of another vehicle;

FIG. 12 is a flowchart showing an example of processing to be executed by a vehicle control apparatus of FIG. 1;

FIG. 13 is a flowchart showing an example of the processing to be executed by the vehicle control apparatus of FIG. 1;

FIG. 14 is a view showing an example of another target;

FIG. 15 is a view showing an example of restricting an area in which a target is detected by sensors; and

FIG. 16 is a view showing an example of determining the consistency between targets according to the type.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

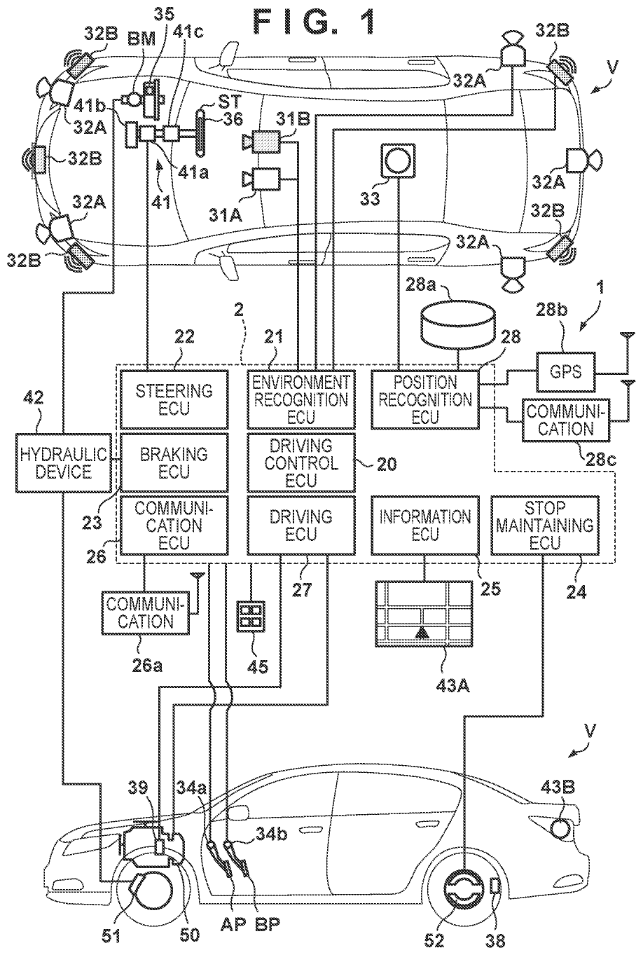

FIG. 1 is a block diagram of a vehicle V and a control apparatus 1 according to one embodiment of the present invention. FIG. 1 shows the schematic arrangement of the vehicle V in a plan view and a side view. As an example, the vehicle V is a sedan-type four-wheeled passenger car.

The vehicle V according to this embodiment is, for example, a parallel-type hybrid vehicle. In this case, a power plant 50 that is a traveling driving unit configured to output a driving force to rotate the driving wheels of the vehicle V can include an internal combustion engine, a motor, and an automatic transmission. The motor can be used as a driving source configured to accelerate the vehicle V and can also be used as a power generator at the time of deceleration or the like (regenerative braking).

<Control Apparatus>

The arrangement of the control apparatus 1 that is an onboard apparatus of the vehicle V will be described with reference to FIG. 1. The control apparatus 1 includes an ECU group (control unit group) 2. The ECU group 2 includes a plurality of ECUs 20 to 28 configured to be communicable with each other. Each ECU includes a processor represented by a CPU, a storage device such as a semiconductor memory, an interface to an external device, and the like. The storage device stores programs to be executed by the processor, data to be used by the processor for processing, and the like. Each ECU may include a plurality of processors, storage devices, and interfaces. Note that the number of ECUs and the provided functions can appropriately be designed, and they can be subdivided or integrated as compared to this embodiment. Note that in FIG. 1, the names of representative functions of the ECUs 20 to 28 are added. For example, the ECU 20 is described as “driving control ECU”.

The ECU 20 executes control associated with traveling support including automated driving of the vehicle V. In automated driving, driving (acceleration or the like of the vehicle V by the power plant 50), steering, and braking of the vehicle V are automatically performed without requiring an operation of the driver. Additionally, in manual driving, the ECU 20 can execute, for example, traveling support control such as collision reduction brake or lane departure suppression. In the collision reduction brake, when the possibility of collision against a front obstacle rises, actuation of a brake device 51 is instructed to support collision avoidance. In the lane departure suppression, when the possibility of departure of the vehicle V from the traveling lane rises, actuation of an electric power steering device 41 is instructed to support lane departure.

The ECU 21 is an environment recognition unit configured to recognize the travel environment of the vehicle V based on the detection results of detection units 31A, 31B, 32A, and 32B configured to detect the state of the periphery of the vehicle V The detection units 31A, 31B, 32A, and 32B are sensors that can detect a target outside the vehicle. In this embodiment, the detection units 31A and 31B are cameras (to be sometimes referred to as the cameras 31A and 31B hereinafter) that capture the front side of the vehicle V and are provided on the front portion of the roof on the in-vehicle side of the windshield of the vehicle V. When images captured by the cameras 31A and 31B are analyzed, the contour of a target or a division line (a white line or the like) of a lane on a road can be extracted.

In this embodiment, each detection unit 32A is a LiDAR (Light Detection and Ranging) (to be sometimes referred to as the LiDAR 32A hereinafter), and detects a target on the periphery of the vehicle V or measures the distance to a target. In this embodiment, five LiDARs 32A are provided; one at each corner of the front portion of the vehicle V, one at the center of the rear portion, and one on each side of the rear portion. Each detection unit 32B is a millimeter wave radar (to be sometimes referred to as the radar 32B hereinafter), and detects a target on the periphery of the vehicle V or measures the distance to a target. In this embodiment, five radars 32B are provided; one at the center of the front portion of the vehicle V, one at each corner of the front portion, and one at each corner of the rear portion.

The ECU 22 is a steering control unit configured to control the electric power steering device 41. The electric power steering device 41 includes a mechanism that steers the front wheels in accordance with the driving operation (steering operation) of the driver on a steering wheel ST. The electric power steering device 41 includes a driving unit 41a including a motor that generates a driving force (to be sometimes referred to as a steering assist torque) to assist the steering operation or automatically steer the front wheels, a steering angle sensor 41b, a torque sensor 41c that detects a steering torque (to be referred to as a steering burden torque which is discriminated from the steering assist torque) borne by the driver, and the like. The ECU 22 can also acquire the detection result of a sensor 36 configured to detect whether the driver is gripping the steering handle ST, and can monitor the grip state of the driver.

The ECU 23 is a braking control unit configured to control a hydraulic device 42. The braking operation of the driver on a brake pedal BP is converted into a liquid pressure by a brake master cylinder BM and transmitted to the hydraulic device 42. The hydraulic device 42 is an actuator capable of controlling the liquid pressure of hydraulic oil supplied to the brake device (for example, a disc brake device) 51 provided on each of the four wheels based on the liquid pressure transmitted from the brake master cylinder BM, and the ECU 23 drives and controls a solenoid valve and the like provided in the hydraulic device 42. At the time of braking, the ECU 23 can light a brake lamp 43B. This can raise the attention of a following vehicle to the vehicle V.

The ECU 23 and the hydraulic device 42 can form an electric servo brake. The ECU 23 can control, for example, distribution of a braking force by the four brake devices 51 and a braking force by regenerative braking of the motor provided in the power plant 50. The ECU 23 can also implement an ABS function, traction control, and the posture control function of the vehicle V based on the detection results of a wheel speed sensor 38 provided on each of the four wheels, a yaw rate sensor (not shown), and a pressure sensor 35 that detects the pressure in the brake master cylinder BM.

The ECU 24 is a stop maintaining control unit configured to control an electric parking brake device (for example, a drum brake) 52 provided on the rear wheels. The electric parking brake device 52 includes a mechanism that locks the rear wheels. The ECU 24 can control lock of the rear wheels and lock cancel by the electric parking brake device 52.

The ECU 25 is an internal notification control unit configured to control an information output device 43A that notifies information in the vehicle. The information output device 43A includes, for example, a head up display or a display device provided on an instrument panel or a sound output device. The information output device 43A may also include a vibration device. The ECU 25 causes the information output device 43A to output, for example, various kinds of information such as a vehicle speed and an outside temperature, information such as a route guide, and information about the state of the vehicle V.

The ECU 26 includes a communication device 26a for wireless communication. The communication device 26a can perform wireless communication to exchange information with a target that has a communication function. A target that has a communication function can be, for example, a vehicle (vehicle-to-vehicle communication), a fixed facility such as a traffic light, a traffic monitoring device, or the like (road-to-vehicle communication), or a person (a pedestrian, a cyclist, or the like) holding a portable terminal such as a smartphone or the like.

The ECU 27 is a driving control unit configured to control the power plant 50. In this embodiment, one ECU 27 is assigned to the power plant 50. However, one ECU may be assigned to each of the internal combustion engine, the motor, and the automatic transmission. The ECU 27, for example, controls the output of the internal combustion engine or the motor or switches the gear range of the automatic transmission in correspondence with the vehicle speed or the driving operation of the driver detected by an operation detection sensor 34a provided on an accelerator pedal AP or an operation detection sensor 34b provided on the brake pedal BP. Note that the automatic transmission is provided with a rotation speed sensor 39 configured to detect the rotation speed of the output shaft of the automatic transmission as a sensor that detects the traveling state of the vehicle V. The vehicle speed of the vehicle V can be calculated from the detection result of the rotation speed sensor 39.

The ECU 28 is a position recognition unit configured to recognize the current position or track of the vehicle V. The ECU 28 performs control of a gyro sensor 33, a GPS sensor 28b, and a communication device 28c and information processing of a detection result or a communication result. The gyro sensor 33 detects the rotary motion of the vehicle V. The track of the vehicle V can be determined based on the detection result of the gyro sensor 33 and the like. The GPS sensor 28b detects the current position of the vehicle V. The communication device 28c performs wireless communication with a server that provides map information and traffic information and acquires these pieces of information. A database 28a can store accurate map information. The ECU 28 can more accurately specify the position of the vehicle V on a lane based on the map information and the like.

An input device 45 is arranged inside the vehicle so as to be operable by the driver and receives an instruction or information input by the driver.

<Example of Control>

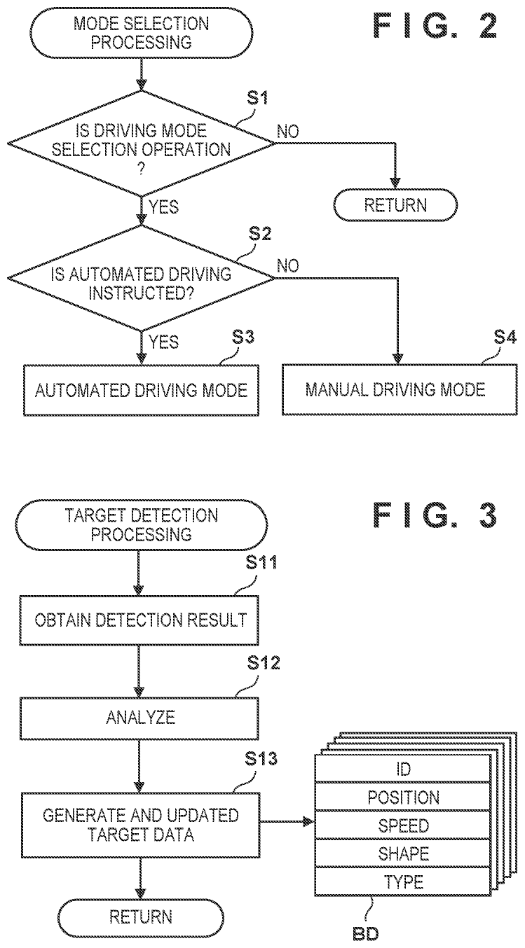

An example of control of the control apparatus 1 will be described. FIG. 2 is a flowchart showing mode selection processing of driving control executed by the ECU 20.

In step S1, it is determined whether a mode selection operation is performed by the driver. The driver can instruct switching between an automated driving mode and a manual driving mode by, for example, an operation on the input device 45. If a selection operation is performed, the process advances to step S2. Otherwise, the processing ends.

In step S2, it is determined whether the selection operation instructs automated driving. If the selection operation instructs automated driving, the process advances to step S3. If the selection operation instructs manual driving, the process advances to step S4. In step S3, the automated driving mode is set, and automated driving control is started. In step S4, the manual driving mode is set, and manual driving control is started. Current settings concerning the mode of driving control are notified from the ECU 20 to the ECUs 21 to 28 and recognized.

In the automated driving control, the ECU 20 outputs a control instruction to the ECUs 22, 23, and 27 to control the steering, braking, and driving of the vehicle V, thereby automatically making the vehicle V travel without the driving operation of the driver. The ECU 20 sets the traveling route of the vehicle V and causes the vehicle V to travel along the set traveling route by referring to the position recognition result of the ECU 28 or a target recognition result. In the manual driving control, driving, steering, and braking of the vehicle V are performed in accordance with the driving operation of the driver, and the ECU 20 executes traveling support control as needed.

<Recognition of Target>

Targets in the periphery of the vehicle V are recognized based on the detection results of the detection units 31A, 31B, 32A, and 32B. FIG. 3 shows generation/update processing of target data that is periodically executed by the ECU 21.

In step S11, the detection result of each detection unit is obtained. In step S12, each detection result obtained in step S11 is analyzed to recognize each target. In S13, target data is generated and updated. The ECU 21 stores and manages target data BD in an internal storage device. Target data BD is generated for each target, and if a target is recognized as an already known target in step S12, the contents of the corresponding target data BD stored in the internal storage device are updated as needed. If a target is recognized as a new target in step S12, the corresponding target data BD is newly generated for this target.

The target data BD exemplified here includes an ID added to each target, the position information of the target, information of the speed of the movement of the target, information of the shape of the target, and the type of the target. The type of the target may include classifications such a fixed body and a moving body. The type of the moving body may further include classifications such as an automobile (four-wheeled vehicle), a motorcycle, a pedestrian, and the like.

<Uniform Operation or Cooperative Operation of Plurality of Vehicles>

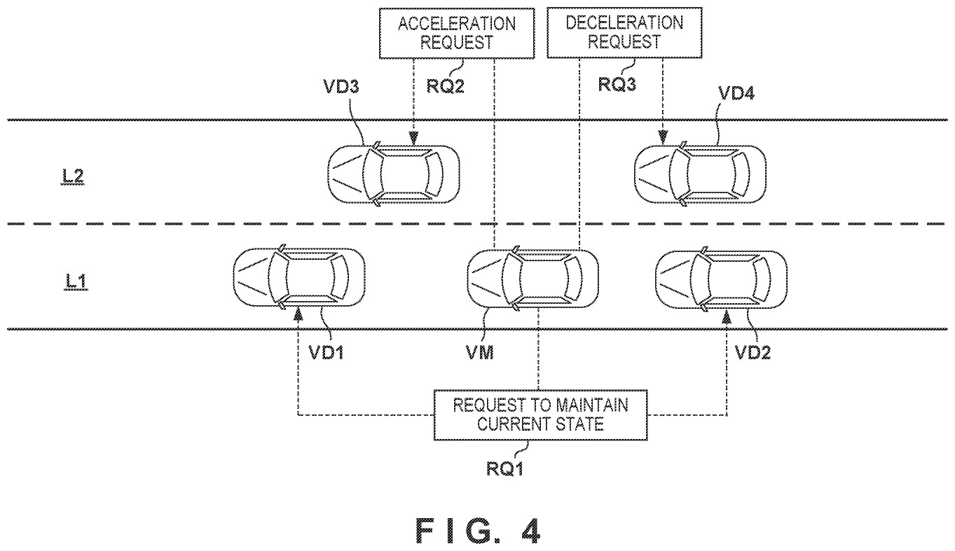

A plurality of vehicles can perform a uniform operation or a cooperative operation by using vehicle-to-vehicle communication by the communication device 26a. FIG. 4 shows an example of such an operation.

FIG. 4 shows an example in which the vehicle V serves as a master vehicle VM and requests, via vehicle-to-vehicle communication, other vehicles VD1 to VD4 that have communication functions to perform an operation. The vehicles VD1 to VD4 are assumed to have the same level of functions as the vehicle V

This example assumes a state in which the master vehicle VM and the vehicles VD1 to VD4 can control, to a certain degree, the travel on the vehicle side, such as a state in which automated driving or automatic preceding vehicle following control for automatically following a preceding vehicle or the like is being performed. Furthermore, this example assume a state in which the master vehicle VM changes lanes from a current travel lane L1 to a travel lane L2.

After establishing communication with the other vehicles VD1 to VD4, the master vehicle VM transmits, to each of the vehicles VD1 and VD2, a request RQ1 for the continuation of the current travel state. The master vehicle VM will also transmit an acceleration request RQ2 to the vehicle VD3 and a deceleration request RQ3 to the vehicle VD4. When each of the vehicles VD1 to VD4 has approved and executed the corresponding request, the following distance between the vehicle VD3 and the vehicle VD4 will increase. The master vehicle VM will move to this space to make a lane change.

In this manner, the master vehicle VM can smoothly change lanes by requesting the other vehicles VD1 to VD4 to perform corresponding operations. Hence, such a communication usage mode can contribute to improving the flow and the safety of traffic.

However, there can be a case in which a vehicle (to be also referred to as a non-participating vehicle) that has not established communication with the master vehicle VM is present near the master vehicle VM. A non-participating vehicle can include a vehicle which has a communication function and a vehicle which does not have a communication function. It is difficult to recognize the presence of a non-participating vehicle by vehicle-to-vehicle communication, and it will be difficult to perform a uniform operation or a cooperative operation with such a vehicle.

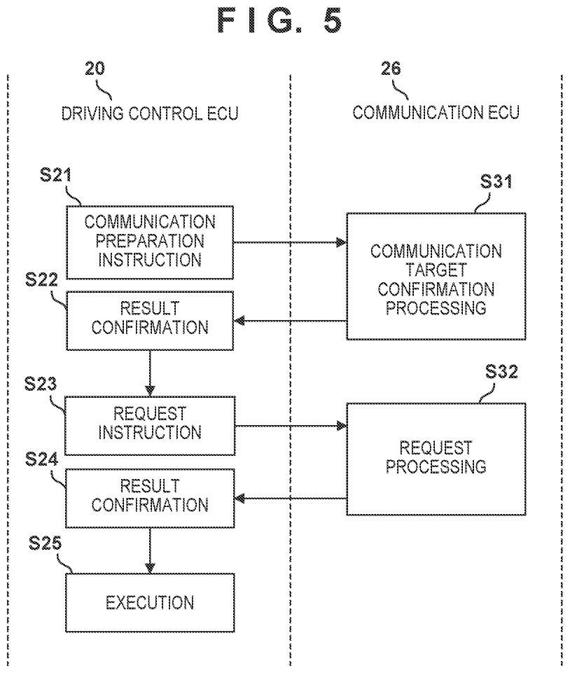

Hence, in this embodiment, the operation of the master vehicle VM is controlled after confirming the presence of the vehicles VD1 to VD4 as communication parties and the presence of a non-participating vehicle by using the target detection results obtained by the detection units 31A, 31B, 32A, and 32B. FIG. 5 is a flowchart showing an example of processing by the control apparatus 1. The processing of FIG. 5 is an example of processing in which a lane change operation is executed by the ECU 20 after causing the ECU 26 to confirm each communication party when, for example, it has been determined that the vehicle VM needs to perform a lane change operation as exemplified in FIG. 4. Note that in the description of this specification, a target to be the communication party of the communication device 26a may be referred to as a communication party target or a communication party vehicle. In addition, a target detected by the detection units 31A, 31B, 32A, and 32B may be referred to as a detected target or a detected target vehicle.

In FIG. 5, the ECU 20 transmits a communication preparation instruction to the ECU 26. This is a preprocessing operation for the ECU 20 to execute the lane change operation exemplified in FIG. 4. Upon receiving the communication preparation instruction, the ECU 26 executes communication target confirmation processing in step S31. The ECU 26 will perform this processing (to be described in detail later) to notify the ECU 20 of whether the request to each communication party vehicle has been permitted.

The ECU 20 confirms, in step S22, the notification from the ECU 26 as to whether the request has been permitted, and advances the process to step S23 if the request has been permitted. In step S23, the ECU 20 instructs the ECU 26 to transmit the requests RQ1 to RQ3 exemplified in FIG. 4. Upon receiving the request instruction, the ECU 26 executes request processing in step S32. The ECU 26 will perform this processing (to be described in detail later) to confirm whether each communication party vehicle has approved the request and to notify the ECU 20 as to whether the operation (a lane change in this example) that the ECU 20 is attempting to execute has been permitted.

The ECU 20 confirms, in step S24, the notification from the ECU 26 as to whether the request has been permitted, and advances to step S25 to execute the operation (a lane change in this example) if the request has been permitted.

<Communication Target Confirmation Processing>

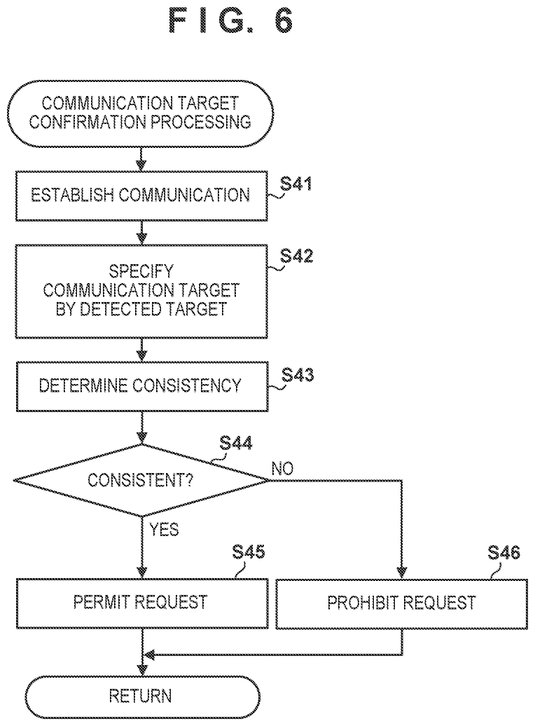

FIG. 6 is a flowchart showing an example of the communication target confirmation processing executed by the ECU 26 in step S31. In step S41, the communication device 26a establishes communication with the other vehicles VD1 to VD4 which are present in the periphery of the vehicle VM. To establish communication, for example, the vehicle VM will broadcast a connection request, and the respective communication devices of the other vehicles VD1 to VD4 will respond to this request. Note that at the point of time of the process of step S41, there may be another vehicle with which communication has been already established by another processing operation in the past. The information of each vehicle with which communication has been established is stored and managed in a storage device included in the ECU 26.

In step S42, a target to be the communication target is specified from the detected targets. More specifically, the target data BD is obtained from the ECU 21, and a target to be the communication target is specified from the target data BD. As an example, assume that a vehicle, particularly, an automobile will be set as the target to be the communication target by referring to the type of the target. A target specified as the communication target may be referred to as a specified target or a specified vehicle in this specification.

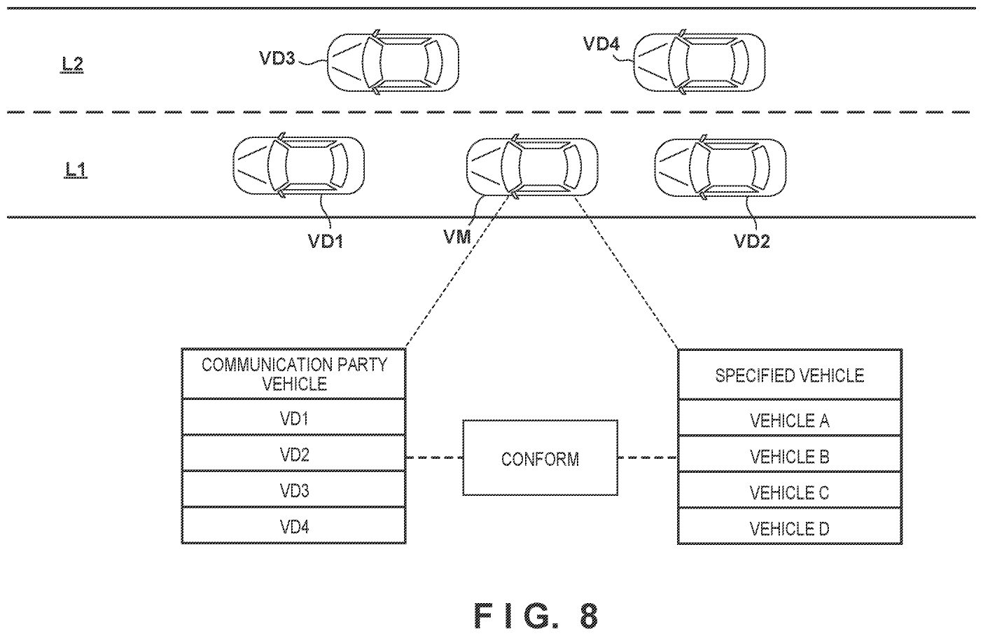

In step S43, consistency between the communication party vehicles VD1 to VD4, with which communication has been established in step S41, and the detected vehicles specified in step S42 is determined. Whether there is consistency between the communication party vehicles and the detected vehicles is determined by, for example, comparing the number of the communication target vehicles and the number of the detected vehicles. FIG. 8 is a view showing an example of consistency determination. In the example shown in FIG. 8, the vehicles VD1 to VD4 are present in the periphery of the vehicle VM, and other vehicles are absent. There are four communication party vehicles VD1 to VD4, and there are four specified vehicles A to D. Hence, it will be determined that there is consistency between the communication target vehicles and the detected vehicles.

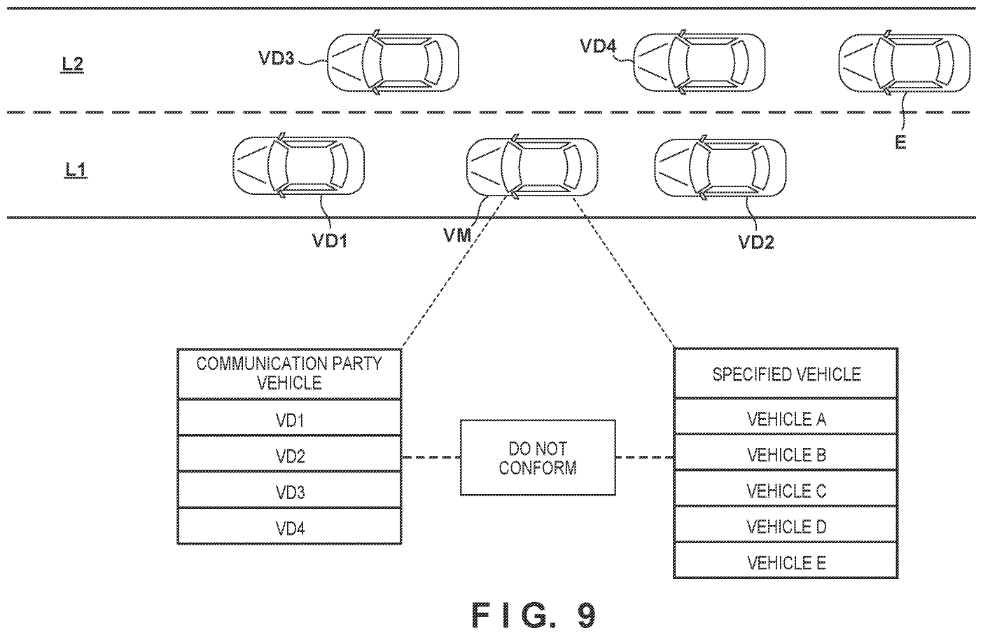

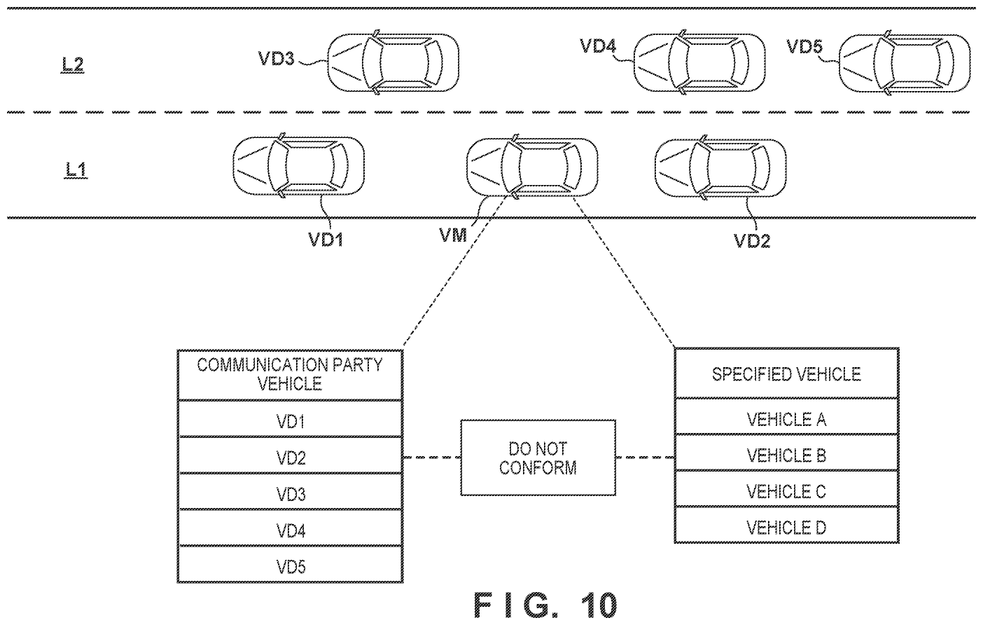

FIGS. 9 and 10 show examples in which it is determined that there is inconsistency between the communication target vehicles and the detected vehicles. In the example of FIG. 9, there are four communication party vehicles VD1 to VD4, and there are five specified vehicles A to E. Communication has not been established between the vehicle VM and the vehicle E, and the number of vehicles with which communication has been established is fewer by one. Hence, it will be determined that there is inconsistency between the communication party vehicles and the detected vehicles. In the example of FIG. 10, there are five communication party vehicles VD1 to VD5, and there are four specified vehicles A to D. In contrast with the example of FIG. 9, the number of detected vehicles is fewer by one. Hence, it will be determined that there is inconsistency between the communication party vehicles and the detected vehicles in this example as well.

Referring back to FIG. 6, in step S44 as the result of consistency determination in step S43, if it is determined that there is consistency between the communication party vehicles and the detected vehicles, the process advances to step S45. In step S45, the ECU 20 is notified of the fact that the request to each of the communication party vehicles VD1 to VD4 has been permitted. If it is determined, as the result of consistency determination, that there is inconsistency between the communication party vehicles and the detected vehicles, the process advances to step S46, and the ECU 20 is notified of the fact that the request to each of the communication party vehicles VD1 to VD4 has not been permitted.

<Request Processing>

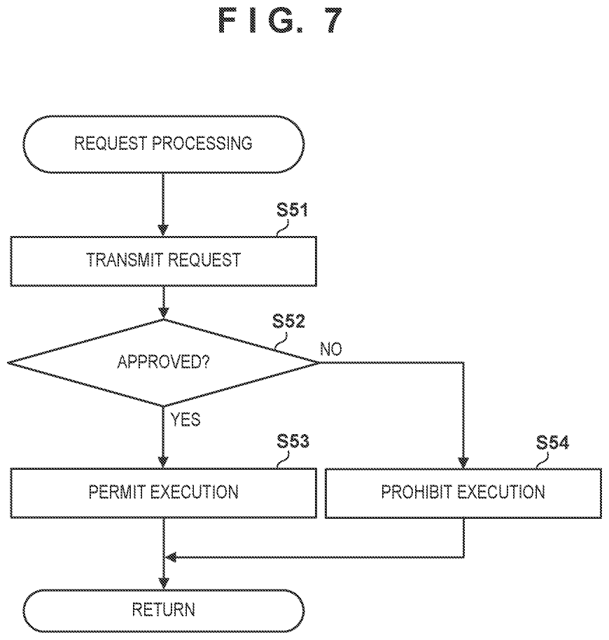

FIG. 7 is a flowchart showing an example of the request processing of step S32 executed by the ECU 26. In step S51, the requests RQ1 to RQ3 are transmitted to the corresponding communication party vehicles VD1 to VD4. Note that a communication party vehicle that does not require a request may be present in some cases. In such a case, a request is not transmitted to this communication party vehicle.

In step S52, whether the approval from each of the communication party vehicles VD1 to VD4, to which the requests have been transmitted, has been received is determined. If approval has been obtained from all of the vehicles, the process advances to step S53. If approval has not obtained from at least one of the vehicles, the request to each vehicle sill be withdrawn, and the process will advance to step S54. In step S53, the ECU 20 is notified that execution of the operation has been permitted. Subsequently, the ECU 20 will execute the lane change operation. In step S54, the ECU 20 is notified that execution of the operation has not been permitted.

In this manner, according to this embodiment, the presence of the communication party vehicles VD1 to VD4 can be confirmed by using the detection results of the detection units 31A, 31B, 32A, and 32B. In addition, executing an action such as a lane change or the like after confirming the presence of the communication party vehicles VD1 to VD4 will allow the action to be executed more reliably.

Note that in this embodiment, consistency determination is performed by using the number of communication party vehicles and the number of specified vehicles as references. However, consistency determination may be performed by using the position of each vehicle as a reference. The position information of each communication party vehicle can be obtained from the communication party vehicle by communication. In this case, the current position may be estimated from the past position information obtained from the communication party vehicle. The position of each specified vehicle may be obtained by using the position information stored in the target data BD.

In addition, a case in which different requests are to be transmitted in accordance with the respective positions of the communication party vehicles VD1 to VD4, as exemplified in FIG. 4, will also require the information of the respective positions of the communication party vehicle. Even in such a case as well, the position information of each communication party vehicle can be obtained from the communication party vehicle by communication or the current position may be estimated from the past position information obtained from the communication party vehicle. Note that the information of the positions of the vehicles VD1 to VD4 is not required in a case in which the same request is to be transmitted regardless of the position of each of the communication party vehicles VD1 to VD4.

This embodiment exemplified a case in which the master vehicle VM performs a lane change. However, the uniform operation or the cooperative operation of a plurality of vehicles is not limited to this, and the embodiment is also applicable to a case in which travel by platooning is to be performed by a plurality of vehicles.

### Second Embodiment

A detected target may not only be that of the detection result obtained by detection units 31A, 31B, 32A, and 32B included in a self-vehicle VM, but may also be a target detected by sensors included by another target. For example, although a communication party vehicle VD5 was not detected in the example of FIG. 10, this may have been because the vehicle VD5 was in the shadows of vehicles VD2 and VD4 and could not be detected by the detection units 31A, 31B, 32A, and 32B.

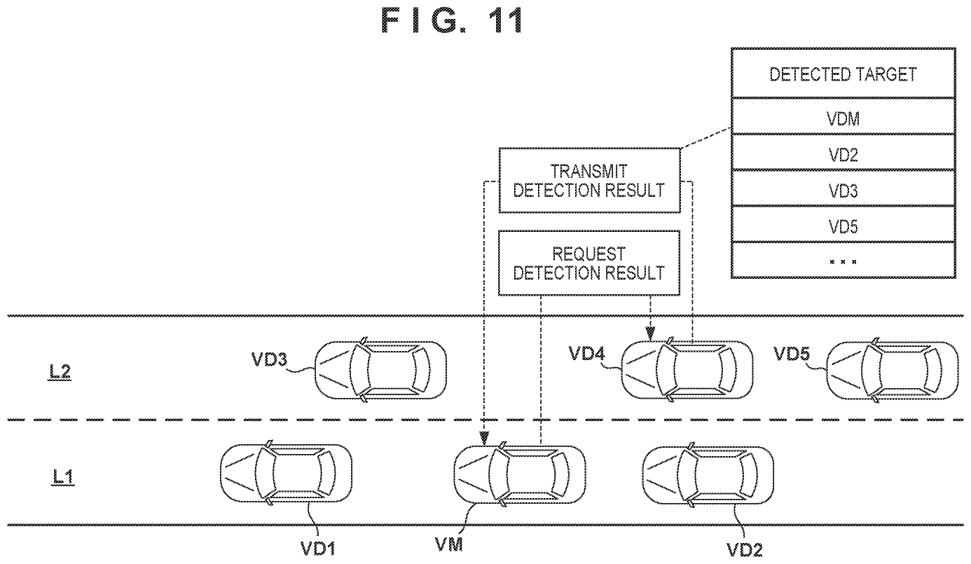

Hence, as shown in the example of FIG. 11, the master vehicle VM can confirm the presence of the vehicle VD5 by requesting the vehicle VD4 to provide the target detection results detected by the sensors included in the vehicle VD4 and receiving the detection results from the vehicle VD4. As a result, the ability to detect a detected target can be improved. The presence of the vehicle VD5 can be affirmed if the detection results of the plurality of targets match (if the vehicle VD5 is included not only in the detection results of the vehicle VD4, but also in the detection results of the vehicle VD2). As a result, the detection accuracy can be improved.

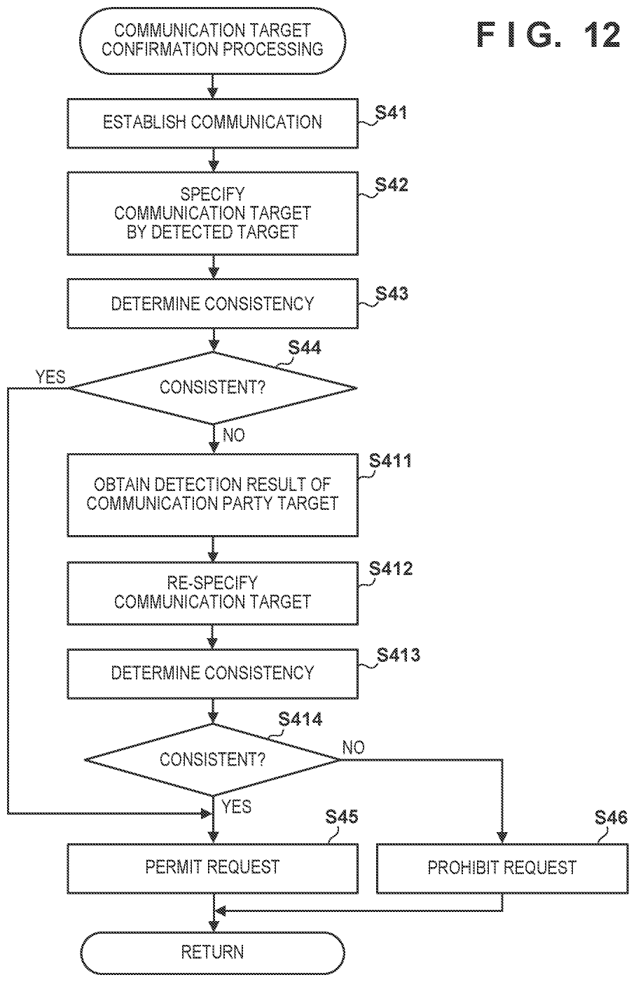

FIG. 12 is a flowchart showing an example of communication target confirmation processing using the detection results of other targets, and is an example of processing which can be performed instead of the communication target confirmation processing of FIG. 6. The processes of step S41 to step S46 are similar to the processes of step S41 to step S46 of FIG. 6, and a description thereof will be omitted.

In the example of FIG. 12, if it is determined in step S44 that there is inconsistency between the communication party vehicles and the detected vehicles, the process advances to step S411. In step S411, the ECU 26 will obtain, from each of the other communication party vehicles, information of targets detected by each communication party vehicle. More specifically, as exemplified in FIG. 11, the ECU 26 will transmit a request to each of the communication party vehicles to provide information of detected targets, and receive information of the detected targets transmitted in response from each of the communication party vehicles.

The ECU 26 will re-specify (step S412) the communication targets based on the information of the detected targets obtained in step S411. For example, if a detected target different from the detected targets specified in step S42 is present, this detected target will be added to the specified targets. Whether a detected target which is different from the detected targets specified in step S42 is present can be determined by, for example, discriminating the difference in the position or the type of the detected target. In step S413, the consistency between the communication party vehicles, with which communication has been established in step S41, and the specified vehicles re-specified in step S412 is determined. This determination is similar to the determination performed in step S43. In step S414, if the result of consistency determination in step S413 indicates that there is consistency between the communication party vehicles and the specified vehicles, the process advances to step S45. Otherwise, the process advances to step S46.

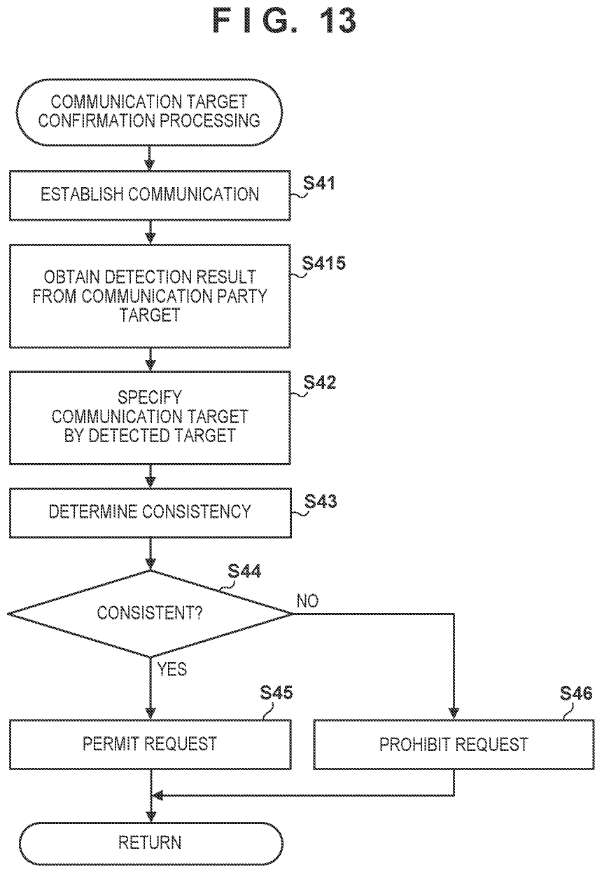

Although information of detected targets is obtained from other targets once it is determined that there is consistency between the communication party vehicles and the detected vehicles in the example of FIG. 12, the information of detected targets may be obtained from the other targets from the beginning. FIG. 13 is a flowchart showing an example of communication target confirmation processing of such an example, and is an example of processing which can be performed instead of the communication target confirmation processing of FIG. 6. The processes of step S41 to step S46 are similar to the processes of step S41 to step S46 of FIG. 6, and a description thereof will be omitted.

In the example of FIG. 13, the ECU 26 executes the process of step S415 after the process of step S41. The process of step S415 is similar to the process of step S411, and the information of targets detected by each of the other communication party vehicles is obtained from each of the other communication party vehicles. Next, in step S42, a target to be a communication target is specified from the detected targets, and a target to be a communication target is specified from target data BD obtained from an ECU 21 and the information of targets obtained from the other communication target vehicles in step S415. Subsequent processes are similar to those of the example of FIG. 6.

### Third Embodiment

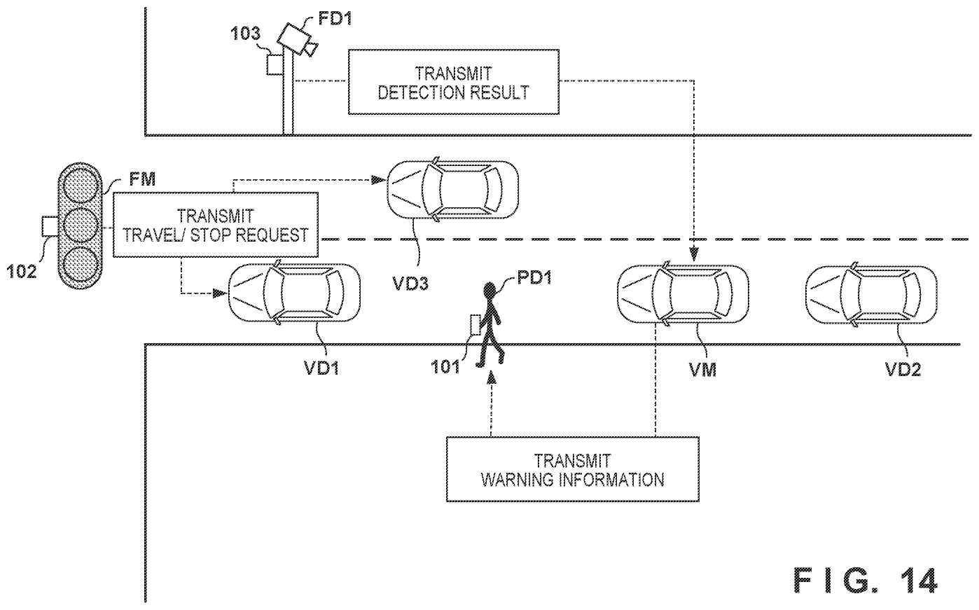

Although vehicles, particularly, four-wheeled vehicles were exemplified as communication party targets and detected targets in the first embodiment and the second embodiment, the present invention is not limited to them. A communication party target can include a fixed body and a moving body that have communication functions. A moving body can include, in addition to a vehicle, a pedestrian who is carrying a portable communication terminal such as a smartphone or the like. FIG. 14 shows an example of an uniform operation or a cooperative operation with other targets.

In FIG. 14, a pedestrian PD1 has been illustrated as an example of a moving body. Since the pedestrian PD1 is carrying a portable communication terminal 101, this pedestrian is assumed to be a target that has a communication function. A master vehicle VM can transmit warning information to the pedestrian PD1. Warning information is, for example, a warning that a vehicle will pass on the lateral side of the pedestrian, a warning that a left or right turning vehicle is present near the pedestrian, a message prompting the pedestrian to walk across a crosswalk because a nearby vehicle will stop, or the like. Traffic safety can be improved by also setting a target such as the pedestrian PD1 as a communication party target and a specified target.

In FIG. 14, a traffic light FM and a monitoring apparatus FD1 are illustrated as examples of fixed bodies. The monitoring apparatus FD1 according to this embodiment is a monitoring camera device that captures an image of a road. Since the monitoring apparatus FD1 includes a communication device 103, it is assumed to be a target that has a communication function. The master vehicle VM can obtain target imaging information from the monitoring apparatus FD1. Traffic safety can be improved by also setting a target such as the monitoring apparatus FD1 as a communication party target and a specified target.

Since the traffic light FM includes a communication device 102, it is assumed to be a target that has a communication function. FIG. 14 shows an example in which the traffic light FM is functioning as a master. That is, a target that is to function as a master is not limited to a vehicle. The communication device 102 will execute processing operations (FIG. 5) similar to those performed by a driving control ECU 20 and a communication ECU 26 to transmit, to a vehicle VD1 and a vehicle VD3, a request to stop or travel at an intersection. As a result, traffic can be controlled smoothly and safely at an intersection.

In the example of FIG. 14, the traffic light FM does not have a sensor for detecting targets. However, the traffic light FM can obtain information of targets in the periphery from the monitoring apparatus FD1, the vehicles VD1 to VD3, and the pedestrian PD1. An arrangement in which the traffic light FM itself has a sensor for detecting targets can also be adopted, as a matter of course.

Note that by setting so that each target will transmit information that indicates its type, it will allow the receiving-side target to easily specify the type of the transmitting-side target. In addition, although either a fixed body or a moving body may be set as the master, it may be arranged so that only a moving body will be set a communication party target and a specified target.

### Fourth Embodiment

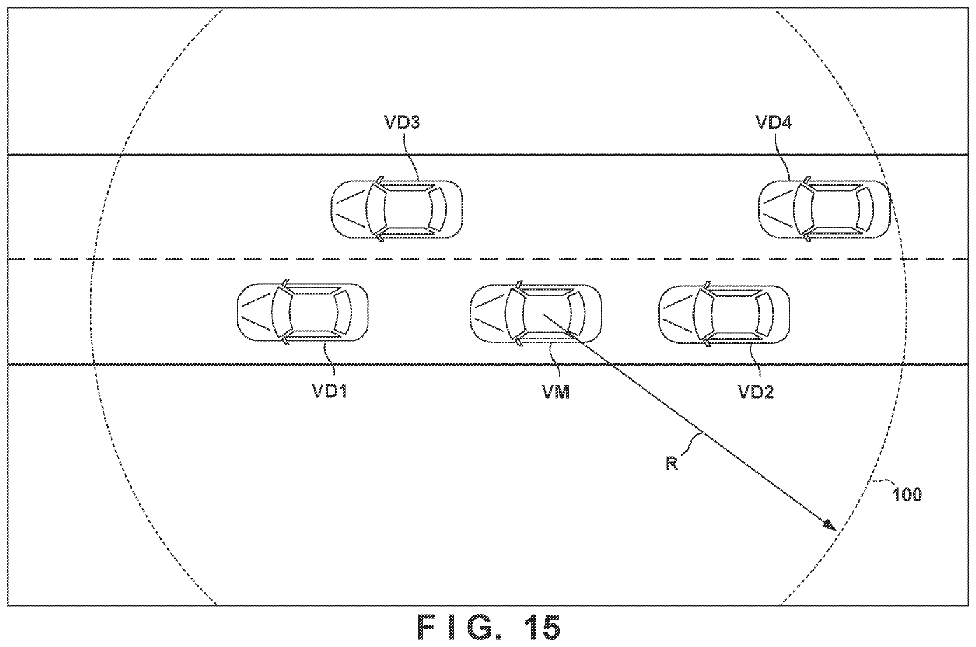

A target to be specified as a communication target is an automobile in step S42 of FIG. 6 in the first embodiment and the second embodiment. However, the specification of a specified target may be restricted by a different condition or by adding another condition. For example, the specification of a specified target may be restricted to targets that are present in a predetermined geographical area based on the position of a master vehicle VM as a reference. FIG. 15 is a view showing such an example.

FIG. 15 shows an example in which a specified target is restricted to each target present within an area 100 of a radius R from the position of the master vehicle VM. The area 100 and the communication range of a communication device 26a may approximately match. By setting so that the area and the communication range will match, the probability that inconsistency will be determined due to recognition of an unnecessary target can be decreased in the determination of the consistency between communication targets and specified targets. The communication range of the communication device 26a can be adjusted by adjusting the intensity of its electromagnetic waves. The area 100 may be scaled up or down in accordance with the travel environment of a vehicle V. For example, the area 100 can be scaled up if the vehicle V is traveling at a high speed, and the area 100 can be scaled down if the vehicle V is traveling at a constant speed. The communication range of the communication device 26a may be scaled up or down in accordance with the increase/decrease in the scale of the area 100.

In addition, the target types to be set as a communication party target and a specified target may be changed in accordance with the travel environment of the vehicle V.

For example, in a case in which the vehicle V is traveling on an expressway, the target types to be set as the communication party target and the specified target may be restricted to vehicles and exclude pedestrians. This is because the possibility that a pedestrian will be present in an expressway is low. On the other hand, in a case in which the vehicle V is traveling on a general road, the target types to be set as the communication party target and the specified target can be set to include not only vehicles but also pedestrians. Decreasing the target types can facilitate reducing the load of the communication processing and the loads of other processing operations. On the other hand, increasing the target types can contribute to improving the safety and the flow of the traffic.

In addition, for example, vehicles traveling on an oncoming lane may be excluded from targets to be set as the communication party targets and specified targets.

### Fifth Embodiment

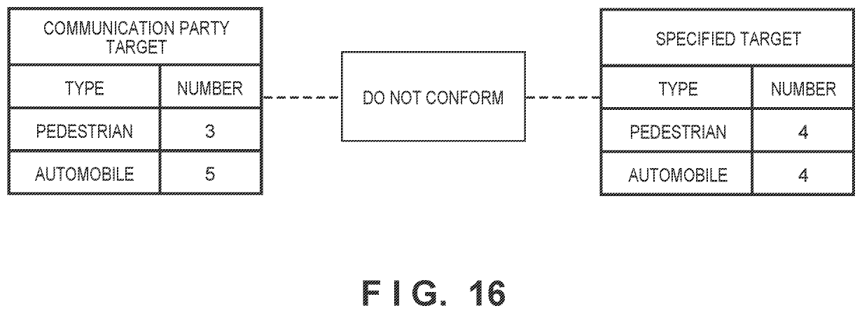

The determination of consistency between communication party targets and specified targets can be performed for each target type. For example, in a case in which consistency determination is to be performed based on the whether the number of communication party targets and the number of specified targets match, the communication party targets and the specified targets may be determined to be inconsistent with each other if the numbers of targets for each type do not match even if the total numbers of targets have matched. FIG. 16 shows such an example. In the example of FIG. 16, the total number of communication party targets is 8 and the total number of specified targets is 8. However, the number of communication party targets and the number of specified targets differ from each other when viewed for each type. Hence, it will be determined that there is inconsistency between the communication party targets and the specified targets.

In addition, the target types to be set as the target of the determination in the consistency determination between the communication party targets and the specified targets can be changed in accordance with the travel environment. For example, in a case in which a vehicle V is traveling on an expressway, the target types to be set as the communication party target and the specified target may be restricted to vehicles and exclude pedestrians. Although pedestrians and automobiles are included as target types to be set as the communication party targets and specified targets in the example of FIG. 16, only automobiles may be set as the comparison targets. In contrast, in a case in which the vehicle V is traveling on a general road, the target types to be set as the communication party target and the specified target may not only include vehicles but also include pedestrians. Reducing the target types is useful in reducing the load of communication processing and the loads of other processing operations. On the other hand, increasing the target types contributes to improving the safety and the flow of traffic.

In another example of consistency determination, the consistency determination may be performed by setting a principle and exceptions. For example, in a case in which consistency determination is to be performed based on the matching of the numbers of targets, the communication party targets and the specified targets may be determined to be inconsistent with each other in principle if the number of communication party targets and the number of specified targets do not match. However, the communication party targets and the specified targets may be determined to be consistent with each other if a predetermined condition is applicable. This arrangement can prevent unnecessary restriction of opportunities for executing action.

A case in which a predetermined condition is applicable is, for example, a case in which the number of communication party targets and the number of specified targets do not match as a result of a vehicle traveling on an oncoming lane being included as a communication party target even though this vehicle traveling on the oncoming lane is not included as a specified target. In a case in which control that need not consider a vehicle traveling on the oncoming lane is to be performed, the vehicle traveling on the oncoming lane can be ignored if the vehicle is included in the communication area, but is not detected by the sensors. This exception is also similarly applicable to a case in which a vehicle traveling on an oncoming lane is included as a specified target but is not included as a communication party target.

In addition, the number of communication party targets and the number of specified target may not match each other as a result of, for example, a pedestrian present in a shop or a park along the road being included as a communication party target event though it is not included as a specified target. In a case in which control that need not consider such a pedestrian is to be performed, this pedestrian can be ignored if this pedestrian is included in the communication area, but is not detected by the sensors. This exception is also similarly applicable to a case in which a pedestrian who is present in a park is included as a specified target, but is not included as a communication party target because this pedestrian does not have a communication terminal.

### Summary of Embodiments

The above-described embodiments disclose at least the following embodiments.

1. A vehicle (for example, V) according to the above-described embodiment, comprises:

a communication unit (for example, 26a) configured to communicate with a target that has a communication function;

a detection unit (for example, 31A, 31B, 32A, 32B) configured to detect a target outside the vehicle;

a specification unit (for example, 26, S42) configured to specify, from targets detected by the detection unit, a target to be a communication target; and a determination unit (for example, 26, S43) configured to determine consistency between a communication party of the communication unit and the target specified by the specification unit.

According to this embodiment, a technique that allows the presence of a communication destination to be confirmed can be provided.

2. In the above-described embodiment, the determination unit determines whether the number of communication party targets of the communication unit and the number of targets specified by the specification unit match.

According to this embodiment, consistency can be determined comparatively easily.

3. The vehicle according to the above-described embodiment, further comprises:

an obtainment unit (for example, 26, 5411, 5415) configured to obtain, by using a communication between the communication unit and the target that has the communication function, information of another target, which is detected by the target that has the communication function, than the target that has the communication function,

wherein the specification unit specifies, from the another target included in the information and the target detected by the detection unit, a target to be a communication target.

According to this embodiment, target detection probability can be improved to improve the accuracy of consistency determination.

4. In the above-described embodiment, the determination unit determines the consistency based on positions of communication party of the communication unit and a target specified by the specification unit.

According to this embodiment, the presence of a communication target can be confirmed with more accuracy.

5. In the above-described embodiment, the determination unit determines, for each target type, whether the number of communication party targets of the communication unit and the number of targets specified by the specification unit match.

According to this embodiment, consistency determination can be determined comparatively easily with more accuracy.

6. In the above-described embodiment, the determination unit changes, in accordance with a travel environment of the vehicle, the target type to be a determination target.

According to this embodiment, the processing load can be reduced by reducing the target types.

7. In the above-described embodiment, the specification unit changes, in accordance with a travel environment of the vehicle, a type of target to be set as the communication target.

According to this embodiment, the processing load can be reduced by reducing the target types.

8. In the above-described embodiment, the determination unit determines that, in a case in which the number of communication party targets of the communication unit and the number of targets specified by the specification unit match, there is consistency between the communication party targets of the communication unit and the targets specified by the specification unit,

the determination unit determines that, in a case in which the number of communication party targets of the communication unit and the number of targets specified by the specification unit do not match, there is inconsistency between the communication party targets of the communication unit and the targets specified by the specification unit, and

the determination unit determines that, in a case in which a predetermined condition is applicable even when the number of communication party targets of the communication unit and the number of targets specified by the specification unit do not match, there is consistency between the communication party targets of the communication unit and the targets specified by the specification unit.

According to this embodiment, it is possible to prevent unnecessary restriction of opportunities for executing action.

9. In the above-described embodiment, the communication target is at least a target present in a predetermined area (for example, 100) based on the position of the vehicle as a reference.

According to this embodiment, a target unnecessary for determination can be excluded.

10. The vehicle according to the above-described embodiment, further comprises:

a request transmission unit (for example, 26, S32) configured to transmit a request to the target, that has the communication function, by using a communication between the communication unit and the target,

wherein in a case in which the determination unit determines that there is consistency between communication party targets of the communication unit and targets specified by the specification unit, the request transmission unit transmits a request to at least one of the communication party targets of the communication unit, and

in a case in which the determination unit determines that there is inconsistency between communication party targets of the communication unit and targets specified by the specification unit, the request transmission unit do not transmit a request to the communication party targets of the communication unit.

According to this embodiment, since a request will be transmitted to a communication target upon confirming the presence of the communication target, a request can be transmitted more accurately.

11. In the above-described embodiment, each of a target with which the communication unit has established communication and a target which the specification unit has specified is a moving body (for example, VD1-VD4, PD1).

According to this embodiment, the presence of a moving body can be confirmed.

12. A communication device (for example, 1, 102) according to the above-described embodiment, comprises:

a communication unit (for example, 26a) configured to communicate with a target that has a communication function;

a obtainment unit (for example, 26, S42, 5411, 5415) configured to obtain a detection result of a sensor configured to detect a target;

a specification unit (for example, 26, S42) configured to specify, from targets included in the detection result, a target to be a communication target; and

a determination unit (for example, 26, S43) configured to determine consistency between a communication party target of the communication unit and the target specified by the specification unit.

According to this embodiment, a technique that allows the presence of a communication target to be confirmed can be provided.

13. A method according to the above-described embodiment, comprises:

a communication step of establishing communication with a target that has a communication function;

an obtainment step of obtaining a detection result of a sensor configured to detect targets;

a specification step of specifying, from targets included in the detection result, a target to be a communication target; and

a determination step of determining consistency between communication party target of the communication step and the target specified in the specification step.

According to this embodiment, a technique that allows the presence of a communication target to be confirmed can be provided.

The invention is not limited to the foregoing embodiments, and various variations/changes are possible within the spirit of the invention.

What is claimed is:

1. A vehicle comprising:
a communication unit configured to communicate with a target that has a communication function;
a detection unit configured to detect a target outside the vehicle;
a specification unit configured to specify, from targets detected by the detection unit, a target to be a communication target; and
a determination unit configured to determine consistency between a communication party target of the communication unit and the target specified by the specification unit,
wherein the determination unit determines whether the number of communication party targets of the communication unit and the number of targets specified by the specification unit match.

2. The vehicle according to claim 1, further comprising:
an obtainment unit configured to obtain, by using a communication between the communication unit and the target that has the communication function, information of another target, which is detected by the target that has the communication function, than the target that has the communication function,
wherein the specification unit specifies, from the another target included in the information and the target detected by the detection unit, a target to be a communication target.

3. The vehicle according to claim 1, wherein the determination unit determines, for each target type, whether the number of communication party targets of the communication unit and the number of targets specified by the specification unit match.

4. The vehicle according to claim 3, wherein the determination unit changes, in accordance with a travel environment of the vehicle, the target type to be a determination target.

5. The vehicle according to claim 1, wherein the specification unit changes, in accordance with a travel environment of the vehicle, a type of target to be set as the communication target.

6. The vehicle according to claim 1, wherein
the determination unit determines that, in a case in which the number of communication party targets of the communication unit and the number of targets specified by the specification unit match, there is consistency between the communication party targets of the communication unit and the targets specified by the specification unit,
the determination unit determines that, in a case in which the number of communication party targets of the communication unit and the number of targets specified by the specification unit do not match, there is inconsistency between the communication party targets of the communication unit and the targets specified by the specification unit, and
the determination unit determines that, in a case in which a predetermined condition is applicable even when the number of communication party targets of the communication unit and the number of targets specified by the specification unit do not match, there is consistency between the communication party targets of the communication unit and the targets specified by the specification unit.

7. The vehicle according to claim 1, wherein the communication target is at least a target present in a predetermined area based on the position of the vehicle as a reference.

8. The vehicle according to claim 1, further comprising:
a request transmission unit configured to transmit a request to the target, that has the communication function, by using a communication between the communication unit and the target,
wherein in a case in which the determination unit determines that there is consistency between communication party targets of the communication unit and targets specified by the specification unit, the request transmission unit transmits a request to at least one of the communication party targets of the communication unit, and
in a case in which the determination unit determines that there is inconsistency between communication party targets of the communication unit and targets specified by the specification unit, the request transmission unit do not transmit a request to the communication party targets of the communication unit.

9. The vehicle according to claim 1, wherein each of a target with which the communication unit has established communication and a target which the specification unit has specified is a moving body.

10. A device comprising a controller including least one processor and at least one storage device, and configured to perform:
communicating with a target that has a communication function;
obtaining a detection result of a sensor configured to detect a target;
specifying, from targets included in the detection result, a target to be a communication target; and
determining consistency between a communication party target in the communicating and the target specified in the specifying,
wherein in the determining, it is determined whether the number of communication party targets in the communicating and the number of targets specified in the specifying match.

11. A method comprising:
communicating with a target that has a communication function;
obtaining a detection result of a sensor configured to detect a target;
specifying, from targets included in the detection result, a target to be a communication target; and
determining consistency between a communication party target in the communicating and the target specified in the specifying,
wherein in the determining, it is determined whether the number of communication party targets in the communicating and the number of targets specified in the specifying match.
